(19) United States
(12) Patent Application Publication
(10) Pub. No.: US 2013/0012627 A1
(43) Pub. Date: Jan. 10, 2013

(54) 2K waterborne polyurethane coating system and methods thereof

(76) Inventor: Randall A. Funston, SR., Wichita Falls, TX (US)

(21) Appl. No.: 13/573,364

(22) Filed: Sep. 11, 2012

Related U.S. Application Data
(63) Continuation-in-part of application No. 12/897,805, filed on Oct. 5, 2010.
Application No. 12/897,805 is a continuation-in-part of application No. 12/388,847, filed on Feb. 19, 2009, now Pat. No. 7,951,869.
Application No. 12/388,847 is a continuation-in-part of application No. 12/128,609, filed on May 28, 2008, now abandoned.

(51) Int. Cl. C09D 175/14; C08K 3/10; C08K 5/17; C08K 5/3475; C08K 5/5415; C08K 3/22

(52) U.S. Cl. 524/91

(57) ABSTRACT

The present system is a waterborne coating system comprising a two-part aqueous polyurethane coating which provides for building solvent based equivalent film thickness without foaming or gassing while retaining properties of little or no volatile organic compound (VOC) or hazardous air pollutant (HAPs) emission. A blend of various acrylic copolomers neutralized in water based emulsion and combined with an emulsified polyester polyol provides the resin system allowing adhesion to a various number of substrates. In at least one embodiment, the acrylic polyol is an acrylic copolymer having the hydrophilizing groups and isocyanate-reactive functionality incorporated into the polymer via appropriate monomer selection or subsequent modification.

### RELATED APPLICATIONS

This application is a continuation-in-part of U.S. patent application Ser. No. 12/897,805, having a filing date of Oct. 5, 2010, which is a continuation-in-part of U.S. application Ser. No. 12/388,847, having a filing date of Feb. 19, 2009, which is a continuation-in-part of U.S. application Ser. No. 12/128,609, having a filing date of May 28, 2008, all of which are hereby incorporated herein by reference.

### TECHNICAL FIELD

The present disclosure relates to a waterborne coating system and method of application and, more particularly, to the use of a two-part aqueous polyurethane coating system which provides for building solvent based equivalent film thickness without foaming or gassing while retaining properties of little or no volatile organic compound (VOC) or hazardous air pollutant (HAPS) emission.

### PRIOR ART

It is known in the prior art, for example in Publication No. US 2004/0220326 to Gurtler, et al to use a certain family of catalysts to cure polyisocyanates with polyols, and to polyurethane systems comprising these. The family of such catalysts is limited to compounds of the elements in the 5^{th} and 6^{th} sub-group of the Periodic Table, in which the element in each case has an oxidation state of at least +4. Such elements are identified in Paragraph [016] at the reference to Gurtler, et al. The present invention is characterized by the fact of using no catalyst identified in the Gurtler, et al reference in Paragraph [16].

Paragraph [16] reads as follows: “It is surprisingly now been found that this object can be achieved with various compounds of elements in the 5^{th} and 6^{th} (sub-) groups of the Periodic Table, in which the elements in each case has an oxidation state of at least +4. Compounds of the elements vanadium, niobium, tantalum, molybdenum, tungsten and tellurium in particular have proved to be suitable. Compounds of the elements vanadium, tantalum, molybdenum, tungsten and tellurium are preferably utilized, thus, for example, salts of molybdic acid such as the alkali metal salts of molybdic acid as well as the alkali metal salts of vanadic acid as well as tetraethylphosphonium molybdate, magnesium molybdate, calcium molybdate, zinc molybdate, lithium tungstate, potassium tungstate, tungstic acid, ammonium tungstate, tungstophosphoric acid, sodium tellurite, sodium niobate and sodium tantalite. Molybdic acid, lithium molybdate, sodium molybdate, potassium molybdate, rubidium molybdate, cesium molybdate, tetramethylammonium molybdate, tetraethylamonium molybdate, molybdenyl acetylacetonate, molybdenum dioxide tetramethylheptadionate, sodium tungstate, potassium tellurite K₂TeO₃, lithium orthovanadate, lithium metavanadate and modifications thereof, sodium orthovanadate, sodium metavanadate as well as ammonium heptamoplybdate are particularly suitable.”

### BACKGROUND OF THE INVENTION

Currently, the coatings industry has been unsuccessful in developing a two part, water-borne polyurethane system that would build film thickness, like a solvent-borne industrial coating, where a minimum film build of two to three mils dry film thickness (DFT) is desired for commercial applications. Film thickness greater than two to three mils wet film thickness (WFT) in a water-borne polyurethane system has resulted in undesirable foaming and gassing. The foaming and gassing is primarily due to the reaction of isocyanate with moisture. Further, current two part, water-borne polyurethane systems cannot achieve the desired product flow during application. The lack of proper flow frequently results with an eggshell type appearance which is unacceptable in higher scale commercial painting. Still further, newer environmental restrictions, that are being implemented across the United States, limit and/or eliminate the use of solvent-borne polyurethanes. Currently, the use of UV curing, polysixolane, high solids using exempt solvents and polyasparitic technologies have been used to attempt an acceptable low VOC/HAP's free system.

Initially, aqueous polyurethane dispersions (PUDs), which may be one and/or two-component coating systems, appeared in response to higher solvent prices and the increased demand for low-VOC coatings. These are usually made by reacting mixtures of polyols and dimcthylolpropionic acid with a polyisocyanate to give a complete polyurethane or an isocyanate-terminated prepolymer. This product is then dispersed in water (which may contain other isocyanate-reactive compounds) by neutralizing the acid groups with a base, typically a tertiary amine. While aqueous PUDs provide a low-VOC alternative to traditional two-component, solvent-based coating formulations, they have some disadvantages. Because they are only lightly crosslinked, coatings from aqueous PUDs often lack adequate solvent resistance, water resistance, gloss, hardness, and weathering properties. In addition, a cosolvent is usually needed for good coalescence, so solvents are not easy to eliminate from the formulations and therefore the mandated environmental requirements of low VOC's and HAPs have been difficult to achieve.

In the early 1990s, two-component (2K) aqueous polyurethane coatings arrived on the scene(see generally: P. Jacobs et al., “Two-Component Waterborne Polyurethane Coatings: Now and Into the Next Century” and cited references). Scientists discovered that it is possible to use water as a carrier for reactive 2K systems and still get coatings with good appearance and physical properties. Two-component aqueous polyurethane coating formulations are typically dispersions of separate polyol and polyisocyanate moieties. A coating film forms after water evaporates and the components react to give a crosslinked polymer network. While 2K aqueous polyurethane coatings should, in theory, match the properties available from solvent-based 2K systems, the coatings have, in practice, lacked adequate water, solvent, and chemical resistance (particularly, but not limited to, resistance to Skydrol), gloss retention, weatherability, flexibility, and impact resistance.

The success of aqueous 2K systems has, until now, relied on some important and often unwieldy formulation twists. For example, the polyol required, which needs both hydroxyl functionality for the polyurethane-forming reaction and acid groups for water dispersibility, is usually not commercially available. In one approach, an acrylatc polymer with acid and hydroxyl functionalitics is made by copolymerizing (in a free-radical polymerization) an acrylic acid monomer and a hydroxyalkyl acrylate monomer (e.g., hydroxyethyl acrylatc or hydroxyethyl methacrylate). Unfortunately, hydroxyalkyl acrylates are rather expensive. In addition, it is difficult to make hydroxyalkyl acrylate polymers that have both high hydroxyl functionality and molecular weights low enough to have value for low-VOC, crosslinkable coating systems. The result is a lower level of coating physical properties than would otherwise be desirable. Recently developed hydroxy-functional acrylate polymers based on allylic alcohols and alkoxylated allylic alcohols overcome some of the limitations of using hydroxyalkyl acrylate monomers. However, the value of these resins has, until now, been demonstrated primarily for solvent-based polyurethane coatings or with high-styrene (>50 wt. %) resins, and not for aqueous polyurethane coatings.

A second common way to tweak the 2K aqueous polyurethane coating formulation is to modify the polyisocyanate. Most of the work to date has used a polyisocyanate modified by partially reacting it with a hydrophilic polyether. Making the polyisocyanate hydrophilic provides an emulsifiable crosslinker having improved compatibility with the co-reactants. This approach also has disadvantages, however. First, the hydrophilic polyisocyanate must be synthesized. Second, more of the expensive hydrophilic polyisocyanate must be used (compared with the unmodified polyisocyanates) to get the same NCO functionality contribution. In the industry, NCO is a functional group made up of nitrogen, carbon and oxygen. Third, the hydrophilicity of the polyisocyanate is incorporated into the coating, often making its water sensitivity unacceptably high.

A third approach modifies the processing while keeping a commercial polyisocyanate in the formulation. The key concern is how to adequately disperse the polyisocyanate in water because emulsions made from commercial polyisocyanates tend to agglomerate and settle. Adding cosolvents and emulsifiers can help, but this at least partially defeats the purpose of using an aqueous system.

At present, two-package solvent-based polyurethane coatings are widely used as coatings for substrates, such as metals, wood, and plastics. These two-package solvent-base urethanes can be cured at room temperature or baked. Such urethanes yield coatings with high levels of mar resistance and chemical resistance. Because these coating compositions are made with organic solvents, which must be liberated into the atmosphere, they cause environmental problems which makes desirable a switch to non-toxic, e.g., aqueous-based compositions. Moreover, because the solvent-containing compositions are often reduced (i.e., thinned) with strong non-polar to medium polar solvents, they often attack and degrade plastic substrates to an undesirable degree. Non-polar thermoplastics, such as aromatic polycarbonates, e.g., of bisphenol-A and phosgene, or polyphenylene ethers, e.g., poly (2,6-dimethyl-1,4-phenylene)ethers, arc capable of being dissolved and/or attacked by such non-polar solvents, and they can be distorted with excessive heat.

### DETAILED DESCRIPTION OF EMBODIMENTS

Described herein is a two-component (2K) water based aqueous coating composition. It should be understood that various terms arc used herein to describe the coating system such as, two-component (2K), two-part, and two-package. Further, the terms aqueous, waterborne, and water based are intended to be synonymous descriptive terms. As such, the specific term utilized should not be viewed as limiting.

Still further, the expression “isocyanate-reactive functionality” as utilized herein refers to the presence of functional groups that are reactive with isocyanate groups under conditions suitable for cured coating formation. Such isocyanate-reactive functionality is generally well known to those skilled in the coatings art and includes, most commonly, active hydrogen-containing functionality such as hydroxyl and amino groups.

By using a blend of various acrylic copolomers neutralized in water based emulsion and at times, depending on final use, combining an emulsified polyester polyol to the resin system, adhesion to a various number of substrates was able to be achieved. Current technology necessary to provide direct to metal coating products that provide chemical resistance, gloss/color retention, and corrosion resistance have been achieved by the use of solvent based coating systems. Typically, such conventional coating products, to directly coat steel substrates, required blast abrasion of the surface prior to application, preferably to SP-5 or SP-10 requirements, to insure adhesion. Further, current aviation coating systems are of a chromate conversion coating which is a type of conversion coating applied to passivate aluminum, zinc, cadmium, copper, silver, magnesium, tin and their alloys to slow corrosion. The process uses various toxic chromium compounds which may include hexavalent chromium and thus may be released into the environment.

Even though water, sand, soda, or other conventional blasting is still a preferred method, the system and method described herein can be applied to clean metal surfaces directly. Further, remarkable adhesion has been achieved on a variety of substrates including, but not limited to, aluminum, galvanized metal (both electroplated and hot-dipped), various stainless steels, PVC, carbon/fiberglass composites, and the like. This coating system can be applied at four (4) to seven (7) mils WFT, without foaming, bubbling, or gassing in the cured film as is typical with conventional water based 2K polyurethane systems that are available in today's market. It should be understood that the foaming, bubbling, and gassing are primarily due to the reaction of isocyanate with moisture. This elimination of foaming and/or gassing is accomplished synergistically using select resins, thickeners, wetting agents, defoamers, pigments, and isocyanates. Further, when combined with MDI (diphenylmethane diisocyanate) and/or HDI (hexamethylene diisocyanate) isocyanates the product meets the military specification requirements for conversion coat primer used by the aviation industry. The instant coating systems can be applied to a variety of solid substrates by conventional methods, such as brush, spray, roller, or dip to form a continuous surface film however the preferred method is spray.

Applicants have discovered that the key to a successful two part water based polyurethane coating has many factors. The acrylic polyol component (also refereed to herein as part A or component A) contains both functionality capable of reacting with isocyanate groups and hydrophilizing functionality capable of rendering the surface active isocyanate reactive material water dispersible. Hydroxyl functionality is typically utilized as the isocyanate-reactive functionality in coatings and is preferred for use in the present system. It should be appreciated that in industry the acrylic polyol (Part A or Component A) is also commercially or proprietarily referred to as an acrylic copolymer, an acrylic urethane polyol, and a waterborne hydroxyl acrylic resin (DSM NeoCryl® ZW 6609). It should be understood that it is contemplated that other manufacturers and users of these or similar copolymers may yet utilize other naming conventions and eventually a common or conventional name will surface. Therefore, the exact naming convention shall not be viewed as a limitation herein. Although a preferred acrylic copolymer has been determined by experimentation and disclosed herein it is further contemplated that future copolymers may be developed with similar properties when mixed in a substantially same manner as disclosed herein. Therefore, such contemplated but perhaps not yet formulated coatings shall not be viewed as a limitation herein.

Locating the correct isocyanate, polyisocyanate, or an isocyanate chemical family compound, or combination thereof (also referred to as part B or component B) along with the correct solvent selection is another major factor. It should be understood, that as described herein and as known to those skilled in the art, the generic chemical family for the preferred isocyanate formulation is an aliphatic polyisocyanate. It should be specifically appreciated that changing even one component of the formulation without months of testing can result in a product failure. All of the components must synergistically work together. The preferred range of mixing Part A and Part B is 3:1. However it is possible that someone familiar with the art could change and have a range from between 1:1 to 8:1 and achieve the same performance characteristics. Thus, the exact and/or preferred methodology of the components disclosed herein, should not be viewed as a limitation herein.

In at least one embodiment, the acrylic polyol is an acrylic copolymer having the hydrophilizing groups and isocyanate-reactive functionality incorporated into the polymer via appropriate monomer selection or subsequent modification. Examples of monomers that may be utilized to synthesize the acrylic polyol include carboxyl group-containing ethylenically unsaturated monomers and hydroxyl group-containing ethylenically unsaturated monomers. It should be appreciated, by those skilled in the art, that the preferred acrylic embodiment is a neutralized acrylic copolymer. It should be noted that some prior art coatings utilize a prepolymer which is a polymer of relatively low molecular weight, usually intermediate between that of a monomer and the final polymer or resin. The preferred acrylic is a heteropolymer or copolymer derived from two (or more) monomeric species as opposed to a homoplymer (prepolymer) where only one monomer is used. Applicant has found two (2) particular proprietary but commercially available compounds that can be utilized in the claimed formulation to achieve the results described herein. The first is commercially available from Cytec and is known as Macrynal® SM 6810w/42WA and another is DSM Neorcz NeoCry10 ZW 6609. It should be noted that there may be others in the industry that would possibly work. However, it may take months of laboratory evaluation and testing to determine their suitability and performance characteristics. Thus, the exact and/or preferred methodology as disclosed herein should not be viewed as a limitation herein.

Although water can be used exclusively, other polar liquid solvents can replace part of the water, e.g., for volatility control. It should be understood that when the use of water is described herein, the description contemplates the use of or addition of other polar liquid media and solvents and as such should not be viewed as a limitation herein. Alcohols and glycol ether's are suitable for such purposes, including lower aliphatic alcohols such as methanol, ethanol, propanol, isopropanol, n-butyl alcohol and t-butyl alcohol. Mixtures of such alcohols can also be utilized.

The coating system, described herein, meets the Military Specification (MIL spec—PRF-85582D) for VOC (50 grams/liter or less) and may be manufactured substantially HAPS free with the proper solvent selection. It should be understood, by those skilled in the art, that the definition of HAPS free is very much solvent dependent. A preferred solvent selection, for at least one embodiment, may result with a HAPS content in a range of 0.0% to 0.04%. Preferably, in another embodiment, the HAPS content is substantially 0.035%. The VOC may also be reduced to substantially zero (0) by one skilled in the art. Application methods, performance criteria, and customer specification may typically determine final VOC and HAPS requirements. In order that those skilled in the art may better understand how to practice the present invention, the following examples are given by way of illustration and not by way of limitation.

In order to achieve the necessary particle size in Part A, certain colors of this coating system must be manufactured under higher shear than can be obtained using high speed dispersion equipment. Preferably, only Part A requires the dispersion mill. However, it should be appreciated that one skilled in the art could vary the herein disclosed preferred methods and systems. It is envisioned that one could possibly use all of the Part A components, with the exception of the resin, in Part B, and come up with the same results. In other words, the pigments, and other additives would be dispersed in the isocyanate as opposed to the resin. Therefore, such “reverse formulations” should not be a viewed as limitations. Preferably, but certainly not a requirement, Part B does not require the use of the same dispersion equipment as utilized with Part A. Part B may be hand stirred or mixed with slow propeller type agitation. Preferably, the required shear for Part A is achieved through, but not limited to, a sand/bead/pebble/SW/horizontal milling process. The addition of all additives is preferably made in a specifically chosen order to obtain the desired performance properties. A preferred method of addition discovered through experimentation and disclosed herein, includes, but in not limited to, adding these first materials to a batch under constant agitation: water, wetting agent, defoamer, dispersing agent, surface additive, and pigment. If the material is not thick enough to have a good grind base additional thickener may be added to obtain the desired consistency. It should be appreciated that one skilled in the art will recognize the desired consistency of a good grind base and as such it need not be further explained in detail. Mixing is preferably continued until uniform while cleaning/scraping the sides of the mixing tub to ensure that substantially all of the material is being mixed. Depending on the desired color, one would select the proper mill, i.e. a sandmill, a sw mill, or a high speed dissolver and grind until a minimum of 7 Hcgman is achieved. In the letdown phase, one may add the resin and any UV absorbers. It should be understood that typically grinding will be in water solution as opposed to the resin. Grinding in the resin, using high shear, may cause a breakdown of the resin properties and possibly destroy the batch. It should be further understood that even as this preferred method is being disclosed herein, one skilled in the art may have utilize other methods or modify this method to achieve the desired results. Therefore, the exemplary method disclosed herein should not be viewed as a limitation hereof.

Thinning is preferably done after mixing the component B with component A. The thinning is preferably limited to a range of 0 to 25% water. It is contemplated herein that those skilled in the art, will recognize, with time and further study, that other methods of thinning may be discovered which still maintain the desired characteristics of the coatings disclosed herein as well as the desired low VOC's and HAP's. Thus, the exact and/or preferred methodology of thinning, disclosed herein, should not be viewed as a limitation herein. It should also be understood that water should never be added to the Part B container and then added to Part A for thinning. This could most likely result in severe foaming and be noted in the application of the coating. It should be further understood that the improper use or the unnecessary elimination of this step (thinning) will likely result in an unwanted viscosity and undesired air entrapment in the coating.

Preferably, the desired 2K coating system is comprised of a part A and a part B. Part A is preferably a carboxyl group-containing an acrylic urethane copolymer. Commercially available arc Macrynal SM 6810w/42WA and/or DSM Ncorcz NcoCryl ZW 6609. These copolymers are preferably dispersed in a polar liquid medium comprising predominantly water. This is understood in the art as using the water as a carrier when manufacturing the resin. The use of solvents may give the product a VOC and possibly HAPS content. Although it should be appreciated that some embodiment may allow certain ranges or limits of VOC and/or HAPS. As an example, not intended as limiting, it has been found that the preferred copolymer, such as Macrynal SM 6810w/42WA, comprises substantially 42% solids by volume and/or weight and the remainder is water. Part B, the generically known aliphatic polyisocyanate, is preferably a hexane, 1,6-diisocyanate-homopolymer poly(oxy-1,2-ethanediyl), alpha-tridecyl-mega,-hydroxy-phosphate. Again it should be understood that there may other be industry known synonyms such as, but not limited to, hydrophilic aliphatic polyisocyanate. Although it should be understood that the above complex is understood by those skilled in the art, for further clarity, as per the MSDS, it is made up of 95% Polyisocyanate Prepolymer based on 1,6-Hexamethylene Diiisocyanate, listing the CAS # as a trade secret. Further comprising 0.1-0.15% Hexamethylene-1.6-Diisocyanate, CAS #822-06-0.

This compound is commercially available as Bayhydur 2319 or Bayhydur 304. It should be understood that other commercially available isocyanatcs such as, but not limited to, MDI, HDI, as well as a blend of both MDI and HDI may work but may not provide the desired properties described and achieved herein. It should also be appreciated that various industry and company specifications, especially the government, in particular the military, call for gloss, semi-gloss, and flat colors. Therefore, the disclosed system may require modification utilizing different isocyanates and flattening agents to obtain a full gloss, (above 90 degrees on a 60 degree gloss meter), semi-gloss, and flat (under 5 degrees on a 60 degree gloss meter), finishes. Preferably, the only modification of the commercial product Bayhydur 2319 or Bayhydur 304 (identified in labeling as the chemical Polyisocyanate Prepolymer Based on 1,6-Hexamethylene Diisocyanate and also containing hexamethylene-1.6-diisocyanate) is the herein disclosed thinning and packaging.

In at least one embodiment, Part A includes solids in a range of 30-70% by weight. In another embodiment Part A may include solids preferably in a range of 45-50% and more preferably in a range of about 53%. It should be appreciated, by those skilled in the art, that when referring to solids one would typically described the solids content Part A and Part B are mixed. Preferably, after Part A and Part B are mixed the solids is in a range of 53% to 61%. It should be appreciated that those skilled in the art would recognize that the higher end of the range may produce a product that is harder to work with particularly for the individual painter. In one embodiment, these solids may be a water dispersible thermoplastic carboxylated acrylic polymer. It should be appreciated that a high solids product should be over 50%. Further, it should be appreciated that many acrylic emulsions may have a solids content in the 40% range but are still not considered as being a high solids product. Still further, this solids content percentage is lowered by 5% or more when water is added. In another embodiment, a zinc having a unique particle structure, further described herein, is added in a range of up to 20% by weight. Again it should be appreciated that the percentages disclosed herein can be somewhat altered by those skilled in the art particularly as new chemical compounds arc found for the polymers, isocyanatcs, and other constituents and should not be viewed as a limitation herein.

Various embodiments of the coating system may be utilized as topcoat for use over primers, Direct To Metal (DTM) topcoat, or a water based zinc primer, and/or a water based zinc conversion coating primer. Each of these coating systems preferably employs the two-component (parts A and B) formulation. It should be noted that the notes below are for guidance regarding preferred use of a particular ingredient. However, it should he understood that the contribution of some ingredients may already be known to those skilled in the art and are therefore not repeated herein. It should also be understood that the examples below are for guidance and are not intended as an exhaustive listing of formulations. Therefore, it is contemplated that the deletion or addition of some additives or constituents may occur and thus should not be viewed as a limitation herein.

### EXAMPLE 1

DTM Topcoat Formulation. The preferred mixture of parts A and B is 3:1 mix ratio by volume. This has currently been found to be the preferred range. However, as disclosed herein, it is possible for one skilled in the art to experiment and change the preferred range from between 1:1 to 8:1 and achieve the same or similar performance characteristics. Thus, the exact and/or 15 preferred methodology of the mixing ratio, disclosed herein, should not be viewed as a limitation herein.

### Part A Formulation:

Acrylic Copolymer (preferred range—20-70%)
Note: As disclosed herein above the Acrylic Copolymer may have a different listed name.
Modified poloydimethyl siloxane (preferred range—0.25-2.0%)

Used as a defoamer and helps prevent air entrapment.

TiO2 (preferred range—10-30%)—(for pigmentation)
Polyurethane based thickening agent (preferred range—0.2-0.5%)

Used to achieve a desired viscosity or thickness of the paint if the viscosity is too low.

Polymeric non-ionic dispersant (preferred range—0.2-0.5%)

Used as a dispersing agent that helps pigments grind easier.

Hindered amine light stabilizer (preferred range—0.2-1.0%)

An UV absorber that helps protect from UV exposure.

Hydroxyphenyl-benzotriazole UV Absorber (preferred range—0.2-1.0%)

An UV absorber that helps protect from UV exposure.

Non-ionic Surfactant (preferred range—0.2-1.0%)

Used as a wetting agent that help wets out the pigment so it will grind easier. Water (preferred range—5-25%)

### Part B Formulation:

Aliphatic polyisocyanate (preferred range—80-100%)

(For example and not intended to be limiting, the commercially available Bayhydur 2319 or Bayhydur 304)

### Thinning Agent for Part B (Aliphatic Polyisocyanate):

Diethylene Glycol Monobutyl Ether (preferred range—0-20%)

It should be noted that this is a preferred chemical and other solvents or thinning agents as well as different ranges of weight and/or volume may be selected and as such should not be viewed as a limitation herein.

### EXAMPLE 2

Water based zinc primer formulation. The preferred mixture of parts A and B is a 3:1 mix ratio by volume.

### Part A Formulation:

Acrylic Copolymer (preferred range—20-70%)

Note: As disclosed herein above the Acrylic Copolymer may have a different listed name.

Modified poloydimethyl siloxane (preferred range—0.25-2.0%)

Used as a defoamer and helps prevent air entrapment.

TiO2 (preferred range—5-10%)—(for pigmentation)
Magnesium silicate (preferred range—5-15%)

Used as a filler and flattening agent.

Calcium Carbonate (preferred range—5-15%)

Used as a filler & extender pigment.

Calcined kaolin clay (preferred range—5-15%) Used as a filler & extender pigment.
Carbon Black (preferred range—0.2-2.0%)

Pigment.

Polyurethane based thickening agent (preferred range—0.2-0.5%)

Used to achieve a desired viscosity or thickness of the paint if the viscosity is too low.

Polymeric non-ionic dispersant (preferred range—0.2-0.5%)

Used as a dispersing agent that helps pigments grind easier.

Hindered amine light stabilizer (preferred range—0.2-1.0%)

An UV absorber that helps protect from UV exposure.

Hydroxyphenyl-benzotriazole UV Absorber (preferred range—0.2-1.0%)

An UV absorber that helps protect from UV exposure.

Non-ionic Surfactant (preferred range—0.2-1.0%)

Used as a wetting agent that help wets out the pigment so it will grind easier

Water (preferred range—5-25%)

### Part B Formulation:

Aliphatic polyisocyanate (preferred range—80-100%)

(For example and not intended to be limiting, the commercially available Bayhydur 2319 or Bayhydur 304)

### Thinning Agent for Part B (Aliphatic Polyisocyanate):

Diethylene Glycol Monobutyl Ether (preferred range—0-20%)

It should be noted that this is a preferred chemical and other solvents or thinning agents as well as different ranges of weight and/or volume may be selected and as such should not be viewed as a limitation herein.
Zinc pigment (preferred range—10-20%) (for pigmentation)

### EXAMPLE 3

Water Based zinc conversion coating primer formulation. The preferred mixture of parts A and B is a 3:1 mix ratio by volume.

### Part A Formulation:

Acrylic Copolymer (preferred range—20-70%)

Note: As disclosed herein above the Acrylic Copolymer may have a different listed name.

Modified polydimethyl siloxane (preferred range—0.25-2.0%)

Used as a defoamer and helps prevent air entrapment.

TiO2 (preferred range—5-10%)—(for pigmentation)
Magnesium silicate (preferred range—5-15%)

Used as a filler and flattening agent.

Calcium Carbonate (preferred range—5-15%)

Used as a filler & extender pigment.

Calcined kaolin clay (preferred range—5-15%)

Used as a filler & extender pigment.

Carbon Black (preferred range—0.2-2.0%)

Pigment.

Polyurethane based thickening agent (preferred range—0.2-0.5%)

Used to achieve a desired viscosity or thickness of the paint if the viscosity is too low.

Polymeric non-ionic dispersant (preferred range—0.2-0.5%)

Used as a dispersing agent that helps pigments grind easier.

Hindered amine light stabilizer (preferred range—0.2-1.0%)

An UV absorber that helps protect from UV exposure.

Hydroxyphenyl-benzotriazole UV Absorber (preferred range—0.2-1.0%)

An UV absorber that helps protect from UV exposure.

Non-ionic Surfactant (preferred range—0.2-1.0%)

Used as a wetting agent that help wets out the pigment so it will grind easier.

Water (preferred range—5-25%)

### Part B Formulation:

Polymeric MDI (preferred range—2-100%)

Provides better moisture resistance in this product.

Aliphatic polyisoeyanate (preferred range—0-8%)

(For example and not intended to be limiting, the commercially available Bayhydur 2319 or Bayhydur 304)

### Thinning Agent for Part B (Aliphatic Polyisocyanate):

Diethylene Glycol Monobutyl Ether (preferred range—0-20%)

It should be noted that this is a preferred chemical and other solvents or thinning agents as well as different ranges of weight and/or volume may be selected and as such should not be viewed as a limitation herein.
Zinc pigment (preferred range—10-20%)

In at least one embodiment, the following performance characteristics were successfully tested:

TOP COAT PERFORMANCE PROPERTIES

| Product: | Aqua Thane series Acrylic Polyurethane | |
|---|---|---|
| Test | Spec Requirements | Test Method |
| V O C | < 50 grams/liter | EPA Method 24 |
| DFT | 2.0-2.5 mils | ASTM D4138-07 |
| Mix Ratio | 3:1 by volume | As formulated |
| Storage Stability | 6 months in plastic container | Manufacture |
| | | Certification |
| Pot Life | 4 hours | #4 Ford - 8 seconds |
| | | increase |
| | | at 4 hours |
| Thinning | 0-25% with water | Manufacture |
| | | Requirement |
| Dry Time | Dry hard: overnight | ASTM D1640 |
| | Full Cure: 7 days | |
| Gloss | > / = 90% | ASTM D523-89 |
| Gloss Retention | > / = 80% | After 500 hours |
| | | Xenon Arc |
| | | testing ASTM D523 |
| Humidity Cabinet | 30 days | ASTM 1)1748 |
| Flexibility | Not less than 10% | GE impact |
| | > / = 4A | ASTM D3359 |
| Adhesion | Immersion in water@ | Visual |
| Water Resistance | 120° F. for 4 days | ASTM 131 17 |
| | 2,000 hour minimum | |
| Salt Spray | 50 MEK rubs | Visual |
| Solvent Resistance | 24 hour immersion in hydraulic | Visual |
| Fluid Resistance | fluid & lubricating oil | |

The coating system described herein is preferably manufactured as follows. Part A is preferably made using high shear by a bead mill to disperse the pigments. Next, a high speed disperser is used to incorporate the resins and additives in the product described herein. Part B is preferably made by blending the isocyanate with diethylene glycol monobutyl ether for the topcoat and diethylene glycol monobutyl ether plus polomeric MDI in the zinc primer. Preferably, the two components are stored at temperatures in a preferred range of between 50-100° F.

It has been discovered, that one of the important features of an additive is the consistency of the zinc. Typically, zinc is added in the form of zinc dust. However, in at least one embodiment, the coating described herein, utilizes a zinc flake instead of dust. Zinc particles typically are found to exist in three forms: powder, dust, and flake. A zinc flake comprises a lamellar type structure and is typically produced from zinc dust by ball milling in anon-reactive fluid such as a hydrocarbon. The milling results in each dust particle being flattened into flake-like form. The primary differences between the powder and dust on the one hand and flake on the other lie in their aspect ratio and their density. The aspect ratio of zinc flake (that is the ratio of diameter to thickness) is typically in the range of about 5:1 to 40:1, and preferably a range of about 15:1 to 25:1, and more preferably about 20:1. Such flakes frequently have a thickness of from 0.5 to 2 microns, for example about 1 micron. Zinc powder on the other hand tends to spheroidal shaped particles having a particle size in the range 15 to 40 microns, whereas dust is also formed primarily of spheroidal particles of a size of from 3 to 15 microns. Zinc flake refers to particles having a particle size of 1 to 100 microns, preferably 6 to 50 microns, and frequently in the range 10 to 15 microns as measured by a Coulter Particle Size Analyzer. Zinc dust has a tapped density above 3. Whereas zinc flake has a tapped density, below 3, for example in the range 2 to 2.5, commonly about 2.4. Thus, a zinc flake provides greater covering power and has lower density than zinc dust. Therefore, the cathodic protection, of the target surface, is preferably both increased and is achieved through the use of less zinc product. Those, skilled in the art, will appreciate this aspect as the “overlap” effect of the flakes (versus dust particles) will provide an improved barrier resistance.

In order to achieve the necessary film formation, this product must be manufactured under higher shear than can be obtained using conventional high speed dispersion equipment. The higher shear is preferably obtained through two separate steps. First a bead mill (such as, but not limited to, a Red Head Horizontal mill) is utilized to disperse the organic and inorganic pigments. The second step preferably blends the resin and predispersed pigment slurry until a homogenous mixture is achieved. Such high speed dispersion equipment may be but is not limited to Myers Cowles High Speed Dispersion Equipment. It should be understood that other methods of achieving the higher shear is contemplated herein and should not be viewed as alimitation herein. It should be further understood that the addition of the additives is preferably in a particular order to obtain the desired sag resistance; however, the exact order of additive addition should not be viewed as a limitation herein.

The preferred method of application requires that the target surface be free of substantially all oil, grease, dirt or other contaminants. Preferably, the surface may be washed with a solvent or other surface cleaner in accordance with SSPC-SP1. However, it should be appreciated that due to environmental issues cleaners other than solvents should be utilized on the target surface. These alternatives to solvent will provide the desired preparation as well as substantially prevent or reduce potential HAPs and/or VOC emissions. It should he understood, by those skilled in the art, that such products are identified in the industry as green adhesion promoters. It should be understood that other cleaning methodology may be employed and the method of cleaning should not be view as a limitation herein. Further, it should be understood that the material of the substrate, to be coated, may direct the preferred materials used for the cleaning.

The surface should also be substantially free of any rust, paint, or other debris which may prevent the coating from being applied to the target substrate. Such preparation may be carried out in accordance with SSPC-SP2. If the surface has been previously painted or coated, it is preferable that any glossy surfaces be sanded or primed. A preferred primer is Aqua-Bond ACWP-W-300 manufactured by Excalibur Paint & Coatings, Ltd (Aqua-Bond is a common law trademark of Excalibur Paint & Coatings, Ltd). If the substrate requires a wash/conversion coating (either by specification or owner requirement), the substrate may preferably be coated with ACWP-W-300 and followed with an intermediate coating of ACWX-W-300 (manufactured by Excalibur Paint & Coatings) and/or ACWP-W-300. It should be understood that in one embodiment, the herein described coating system may, when necessary or desired, be applied directly to a surface substrate with substantially no surface preparation.

For optimum results, the herein described coating system is preferably applied when temperatures are in a range of 60 to 80 degrees Fahrenheit with a relative humidity below 70%. However, those skilled in the art can appreciate that such optimum conditions may be difficult to encounter. As such, application under various circumstances, requiring longer or shorter drying times, and/or artificial temperature controls are contemplated herein and should not be viewed as a limitation of the herein described system and method. As mentioned herein above, the coating system may be applied utilizing a variety of spray systems, brushes, rollers, and the like.

Prior to application, the two components (Part A and Part B) must be mixed. It should be understood that it is not recommended to us use conventional paint shakers or high speed mechanical agitation for this may result in excessive foam. Preferably, each part should be thoroughly mixed in its own container much akin to mixing a conventional container of paint (i.e. so that no pigment remains at the bottom of the container and that the color is uniform). Part B should then be mixed with Part A according to the proper mix ratio by volume for approximately two to three minutes. It should be understood that this mixing time is a preferred range but factors such as mixing equipment, weather, temperature, environment, and the like may influence the required mixture time and should not be viewed as a limitation herein. Preferably, components A and B, when mixed have a pot life of approximately 4 hours at temperatures of about 70 degrees Fahrenheit and a relative humidity of 50%. It should be understood, by those skilled in the art, that the pot life will vary at different conditions and that only a sufficient quantity of parts A and B should be mixed so as to not exceed the pot life thus wasting the coating material. It is further preferable to allow a period of approximately one half hour after mixing parts A and B and prior to the application of the coating system on a target surface. However, this is not a requirement. When necessary or desired, the mixture can be thinned. Preferably, the thinning is done to the base prior to mixing parts A and B by adding up to 25% water, by weight. As disclosed hereinabove, it is contemplated that other thinning methodology may be incorporated and as such should not be viewed as a limitation herein. It should be understood that improper or undesired viscosity and air entrapment could result if thinning is not performed when necessary. Preferably, but not limited to, the thinning is done after Part A and Part B have been mixed. Preferably, thinning should only be done after Parts A and B are mixed by adding up to 25% water by volume. It should be noted that after mixing Part A and Part B, water for thinning should not be added to the empty container of Part B due to a catalytic reaction. Another container should be used for adding water for thinning. It should be further understood that there should be approximately a four hour wait time between topcoating the zinc primer with the urethane topcoat (at the preferred temperature of approximately 75° F.). However, depending on the climatic conditions, recoating may be done in as little as thirty (30) minutes. The topcoat should be given at least a twenty four (24) hour cure time prior to striping, stenciling, or recoating. It should be apparent that this cure time depends on environmental conditions and may vary.

Obviously, other modifications and variations of the present invention are possible in the light of the above teachings. It is therefore to be understood that changes may be made in the particular embodiments described above which are within the full intended scope of the invention as defined in the appended claims.

While the present system and method has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the system or methods disclosed herein to those particular embodiment configurations. These terms may reference the same or different embodiments, and are combinable into aggregate embodiments. The terms “a”, “an” and “the” may also mean “one or more”.

None of the description in this specification should be read as implying that any particular clement, step or function is an essential clement which must be included in the claim scope. The scope of the patented subject matter is defined by the allowed claims and their equivalents. Unless explicitly recited, other aspects of the instant disclosure as described in this specification do not limit the scope of the claims. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. A two-part aqueous coating system comprising:
a first part, said first part being a high solids acrylic copolymer;
the copolymer being dispersed in a polar liquid medium;
a second part, said second part being an isocyanate;
said first part or said second part further comprising additives which substantially prevent foaming and/or gassing when said two-part aqueous coating system is applied at a maximum wet film thickness (WFT); and said two-part aqueous coating system having low volatile organic compounds (VOC) in a range of zero (0) grams/liter to fifty (50) grams/liter when said first part and said second part arc mixed together, wherein said two-part aqueous coating system is substantially free of hazardous air pollutant emissions (HAPs), said coating system being characterized by using no catalyst involving compounds of the elements in the 5^{th} and 6^{th} sub-groups of the Periodic Table, in which the element in each case has an oxidation state of at least +4, wherein said coating can be applied to objects with a wet film thickness of four (4) to seven (7) mils, without foaming, bubbling, or gassing in the cured film.

2. The coating system of claim 1, further comprising a pigment for coloration.

3. The coating system of claim 1, wherein said application at the maximum wet film thickness (WTF) substantially prevents sag.

4. The coating system of claim 1, wherein said two-part aqueous coating system comprises a HAPS content in a range of 0.0% to 0.04%.

5. The coating system of claim 1, said isocyanate is an aliphatic polyisocyanate further comprising a hexane, 1,6-diisocyanate-homopolymer poly(oxy-1,2-ethanediyl), alpha-tridecyl-mega,-hydroxy-phosphate.

6. The coating system of claim 1, said copolymer further comprises a carboxyl group-containing urethane.

7. The coating system of claim 1, said polar liquid medium comprising predominantly water, wherein said water content of the first part and the second part after mixing is in a range of 5-25% by weight and/or volume.

8. The coating system of claim 1, said first part further comprising a range of 45-70% by weight and/or volume of solids basis.

9. The coating system of claim 1, said first part further comprising substantially a range of 51-54% by weight and/or volume of solids basis.

10. The coating system of claim 1, said first part and said second part after mixing further comprising approximately 61% by weight and/or volume of solids basis.

11. The coating system of claim 1, said first part comprising the acrylic copolymer in a range of 30-50% by weight and/or volume.

12. The coating system of claim 1, said first part comprising the acrylic copolymer in a range 10 of 32-34% by weight and/or 37-38% by volume.

13. The coating system of claim 1, said first part and said second part after mixing further comprising the acrylic copolymer in a range of 52%-58% by weight and/or volume.

14. The coating system of claim 1, said second part further comprising a zinc pigment in a range of 10% to less than 20% by weight and/or volume, wherein said zinc pigment is blended together with an isocyanate (MDI) and/or an isocyanate (HDI), and/or aliphatic polyisocyanate or a combination thereof.

15. The coating system of claim 1, said second part further comprising an aliphatic polyisocyanate in a range of 80-100% by weight and/or volume with respect to said second part.

16. The coating system of claim 1, said second part further comprising an aliphatic polyisocyanate in a range of up to 8% by weight and/or volume with respect to said second part.

17. The coating system of claim 1, said second part further comprising a solvent in a range of up to 20% by weight and/or volume.

18. The coating system of claim 1, wherein said first part and said second part are mixed in substantially a 3:1 ratio by volume.

19. The coating system of claim 1, wherein said first part and said second part arc mixed in a ratio range of about a 1:1 to an 8:1 ratio by volume.
